(19) United States
(12) Patent Application Publication
(10) Pub. No.: US 2012/0263474 A1
(43) Pub. Date: Oct. 18, 2012

(54) Method for Arbitrary Optical Microwave and MM-Wave Generation

(75) Inventor: Ming-Fang Huang, Atlanta, GA (US)

(73) Assignee: NEC LABORATORIES AMERICA, INC., Princeton, NJ (US)

(21) Appl. No.: 13/446,596

(22) Filed: Apr. 13, 2012

Related U.S. Application Data
(60) Provisional application No. 61/475,301, filed on Apr. 14, 2011.

(51) Int. Cl. H04J 14/02

(52) U.S. Cl. 398/93

(57) ABSTRACT

A method for an arbitrary optical microwave and mm-wave generation includes generating 2N+1 optical carriers while employing only one continuous wave CW lightwave with a recirculating multi-tone generator; and selecting optical carriers with an arbitrary-frequency optical millimeter-wave generator responsive to the prior generating.

### RELATED APPLICATION INFORMATION

This application claims priority to provisional application No. 61/475,301 filed Apr. 14, 2011, the contents thereof are incorporated herein by reference

### BACKGROUND OF THE INVENTION

The present invention relates generally to optical communications, and more particularly, to a method for arbitrary optical microwave and mm-wave generation.

Compared to time division multiplexed passive optical networks (TDM-PON) with complex scheduling algorithms and framing technology, wavelength division multiplexed. (WDM)-based PON has been proposed as a potential solution to meet the ever-increasing demand for large capacity, low latency, and high security for next generation optical access networks. Moreover, to improve both cost-effectiveness and wavelength control functionality, the reuse of downstream signals for uplink transmission has attracted very strong research interest.

In some of the proposed schemes, downstream and upstream signals were modulated in different formats in order to avoid crosstalk: for example, DPSK/OOK (downstream DPSK and upstream OOK signals), inverse return-to-zero (IRZ)/OOK, etc. However, DPSK modulation requires extra components for the demodulation of the signals, which may increase system cost and complexity. Recently, orthogonal frequency division multiplexing (OFDM) has emerged as an effective modulation format for fiber-optic transmission systems because of its high spectral efficiency and resistance to various sources of linear dispersion, including chromatic dispersion (CD) effects. To exploit these advantages, downstream OFDM and upstream OOK PON architectures have been proposed, however, the uplink performance was limited by distortion of the baseband OOK signal. An alternate approach is the use of reflective semiconductor optical amplifiers (RSOA) to re-modulate the downlink signal. In this case, however, the data rate can be limited by the available RSOA bandwidth.

Accordingly, there is a need for an improvement over existing optical systems.

### BRIEF SUMMARY OF THE INVENTION

The present invention is directed to a method for an arbitrary optical microwave and mm-wave generation that includes generating 2N+1 optical carriers while employing only one continuous wave CW lightwave with a recirculating multi-tone generator; and selecting optical carriers with an arbitrary-frequency optical millimeter-wave generator responsive to the prior generating.

These and other advantages of the invention will be apparent to those of ordinary skill the art by reference to the following detailed description and the accompanying drawings.

### BRIEF DESCRIPTION OF THE DRAWINGS

FIG. 1A, is a block diagram of an exemplary lightwave centralized WDM-OFDM-POM configuration, in accordance with the invention, with the following symbol notations: IL denotes an interleaver, DE/MUX denotes an optical demultiplexer, OF denotes an optical filter, IM denotes an intensity modulator, DS/US denotes a clown/upstream and DS′ denotes re-modulated downstream replica signals;

FIG. 1 is a block diagram of functional details of components shown in FIG. 1A, in accordance with the invention; and

FIG. 2 is a block diagram of further functional details of components shown in FIG. 1A, in accordance with the invention.

### DETAILED DESCRIPTION

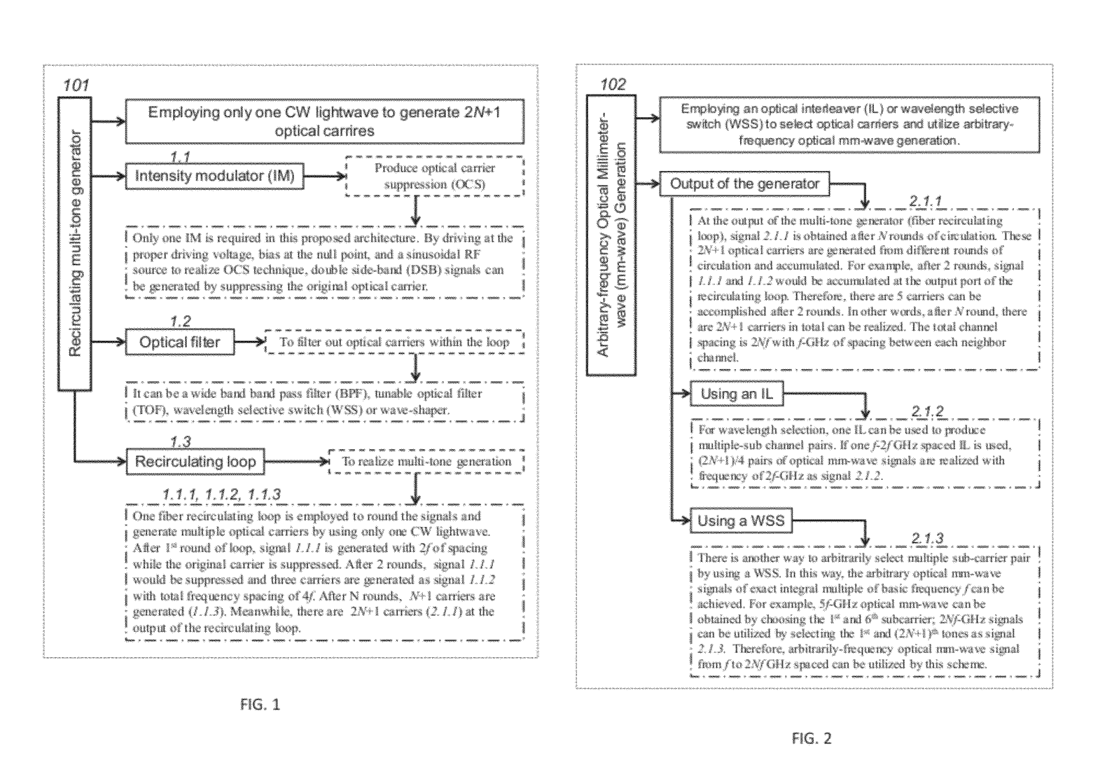

The present invention is directed to a method for generating arbitrary-frequency optical mm-wave by one signal laser source and one low RF bandwidth required intensity modulator. The exemplary optical system configuration in FIG. 1 includes a first lightwave centralized WDM-OFDM-PON configuration enabled by OFDM-remodulated optical network units (ONUs) carried in a RF band. The optical system operates at symmetric data rates of OFDM, and features ONU-side direct detection and a coherent receiver optical line terminal (OLT).

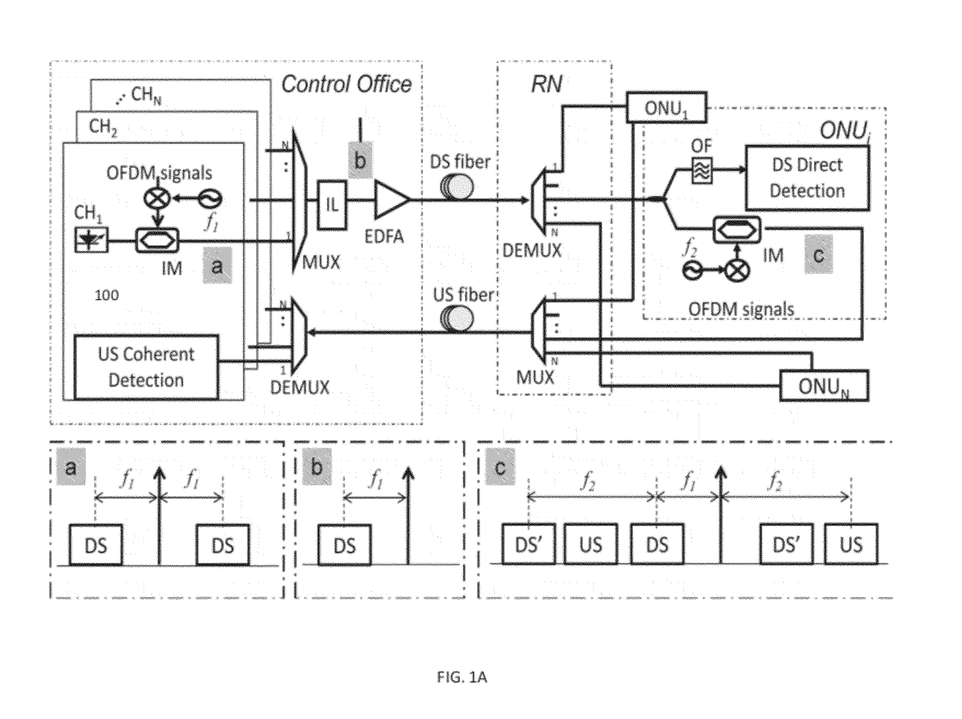

Referring to FIGS. 1A, 1 and 2 together, the principle of the inventive WDM-OFDM-PON configuration is illustrated and explained.

Specifically, looking again at FIG. 1, at the optical line terminal are each of the N OFDM transmitters that contains a distributed feedback (DFB) laser, followed by an intensity modulator (IM), where N denotes the number of WDM channels. On each WDM channel, a 10-Gbit/s OFDM-16QAM signal is up-converted to a high RF carrier frequency, f1, by an analog mixer as an RF source (See FIG. 1A, [symbol] shaded indicated block bottom left). An optical multiplexer (MUX) is employed to combine the WDM channels, with the aggregate signal sent into the feeder fiber for downstream transmission. An interleaver (IL) is used to generate the optical single sideband (SSB) OFDM-16QAM spectrum, which also mitigates any chromatic dispersion (CD)-induced fading effects that would occur from double sideband (DSB) transmission (FIG. 1A, [symbol] shaded indicated block bottom center). In the remote node (RN), an optical de-multiplexer (DEMUX) is used to separate N WDM channels for delivery to N ONUs. At each ONU, the downstream signal is split by a 3-dB coupler, with one output passed to a narrowband optical filter (OF) to remove excess ASE noise, and then fed to a downstream receiver for direct detection. The second output is reused for uplink transmission, i.e., the downstream OFDM-16QAM signal is directly re-modulated by an IM driven by a RF carrier frequency, f2, to produce an independent 10-Gbit/s upstream RF-OFDM-16QAM signal. The resulting re-modulated spectrum is shown in FIG. 1, [symbol] shaded indicated block bottom right. It presents the downstream OFDM signal re-modulation will create independent double-sideband upstream signals (named US, the target signals), as well as undesirable re-modulated downstream replica signals, denoted by DS′. Frequency overlap of DS′ and US bands can be avoided by proper selection of RF frequencies, f1 and f2. After upstream WDM multiplexing, fiber transmission, and OLT-side WDM DEMUX, a coherent receiver is employed at the OLT to select the desired uplink data. To avoid interference from the re-modulated downstream signals, the OLT local oscillator (LO) laser can be tuned to the target uplink data band and down-converted the signals to the baseband, which can also reduce the bandwidth requirement of the DAC. Consequently, the new lightwave-centralized WDM-OFDM-PON architecture at symmetric data rate is realized with source-free ONUs.

Referring to FIGS. 1A and 2, a single continuous wave (CW) lightwave is generated by a laser source and then sent to the recirculating multi-tone generator (101). The multi-tone generator configuration consists of a dosed fiber recirculating loop (1.3), an intensity modulator (IM) (1.1) and two erbium doped fiber amplifiers to compensate the loss of frequency conversion and an optical filter to select the number of tones required. In order to employ optical carrier suppression (OCS), the IM is driven by a sinusoidal RF source with a repetitive frequency of f and proper driving voltage. After one round of a fiber loop, two subcarriers are generated with 2f spacing (1.1.1) when the original carrier at the center frequency of f₀ passes through the IM and incurs a frequency shift equal to the drive voltage frequency of f in each side. The double sideband (DSB) signals (1.1.1) are split into two branches, one couple out and the other recirculating back to the input of the IM. In the second round, three subcarriers are generated (1.1.2) with 4f spacing by shifting (1.1.1) signal. Similarly, in the N^{th} round, it will have N+1 subcarriers shift from the previous N carriers with channel spacing of 2Nf (1.1.3). The N+1 carriers will be filtered out by the optical filter (1.2) placed in the loop. At the output of the recirculating loop, the 2N+1 optical carriers (2.1.1) with 2Nf spacing are coming from different N rounds. One optical interleaver (IL) (2.1) or wavelength selective switch (WSS) is employed to arbitrarily select the multiple sub-channel pair. For example, N pairs of optical mm-wave signals with 2f channels spacing can be obtained (2.1.2) while using f-2f GHz spaced IL. By using WSS, the arbitrary optical mm-wave signals of exact integral multiple of basic frequency f can be achieved. For example, if the repetitive frequency is f GHz, the arbitrary optical mm-wave from 2f GHz to 2Nf GHz (2.1.3) can be accomplished using this invention.

The main benefit for the invention is generation of arbitrary-frequency optical mm-wave by one signal laser source and one low RF bandwidth required intensity modulator. The invention solves the following issues: (a) Number of wavelengths requirement, (b) Bandwidth requirement, and c) Arbitrary frequency requirement.

Number of wavelengths requirement: in order to have multiple channels, different light sources or cascaded two modulators are needed. In this proposed scheme, only one CW lightwave and one intensity modulator are employed. Therefore, after the proposed multi-tone generator, signal lightwave is utilized to support multiple carriers.

Bandwidth requirement: In order to have high frequency of optical mm-wave signal, high frequency components are required such as large bandwidth of modulator, high frequency of sinusoidal RF source and so on. In this proposed architecture, low frequency components can be used to obtain high frequency of optical mm-wave signals.

Arbitrary frequency requirement: In order to obtain different frequency of optical mm-wave, different sinusoidal RF source is used. Here, arbitrary optical mm-wave signals of exact integral multiple of basic frequency f can be achieved.

From the foregoing, it can be appreciated that with the inventive configuration only one CW lightwave is required to realize arbitrary optical microwave and turn-wave generation. This proposed optical mm-wave signals generation employs low RF signal to provide high-repetitive frequency, it is suitable for future photonic mm-wave sources with significant improvement on both system operation efficiency and reliability

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. For example, those of ordinary skill in the art will recognize that multiple configurations for the optical processing path shown in FIG. 4 are possible to achieve the same signal transformation effect. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

1. A method for an arbitrary optical microwave and mm-wave generation, comprising the steps of:
generating 2N+1 optical carriers while employing only one continuous wave CW wave with a recirculating multi-tone generator; and
selecting optical carriers with an arbitrary-frequency optical millimeter-wave generator responsive to said step of generating.

2. The method of claim 1, wherein said recirculating multi-tone generator comprises at the output of said multi-tone generator a fiber recirculating loop, a signal being obtained after N rounds of circulation, these 2N+1 optical carriers being generated from different rounds of circulation and accumulated.

3. The method of claim 2, wherein for said recirculating multi-tone generator, after 2 rounds, a signal would be accumulated at the output port of the recirculating loop with 5 carriers being accomplished after 2 rounds.

4. The method of claim 2, wherein said recirculating multi-tone generator comprises after N rounds with 2N+1 carriers in total being realized and total channel spacing being 2Nf with f-GHz of spacing between each neighbor channel.

5. The method of claim 1, wherein said recirculating multi-tone generator comprises an intensity modulator for optical carrier suppression, with said intensity modulator being driven at a proper driving voltage, bias at a null point, and a sinusoidal RF source to realize said optical carrier suppression and double sideband signals capable of being generated by suppressing an original said optical carrier.

6. The method of claim 1, wherein said recirculating multi-tone generator comprises one fiber recirculating loop for rounding signals and generating multiple optical carriers by using only one continuous lightwave, wherein after a first round of loop, a first signal is generated with 2f of spacing while the original carrier is suppressed, after 2 rounds said signal would be suppressed and three carriers are generated as a second signal with a total frequency spacing of 4f, and after N rounds, N+1 carriers are generated, while there are 2N+1 carriers at an output of said recirculating loop.

7. The method of claim 1, wherein said arbitrary-frequency optical millimeter-wave generator comprises an interleaver for wavelength selection, wherein one interleaver can be used to produce multiple-sub channel pairs and when one f-2f GHz spaced interleaver is used, (2N+1)/4 pairs of optical mm-wave signals are realized with frequency of 2f-GHz as signal.

8. The method of claim 1, wherein said arbitrary-frequency optical millimeter-wave generator comprises a wavelength selective switch for arbitrarily selecting a multiple sub-carrier pair, wherein said arbitrary optical mm-wave signals of exact integral multiple of basic frequency f can be achieved.

9. The method of claim 8, wherein said arbitrary-frequency optical millimeter-wave generator comprises obtaining a 5f-GHz optical mm-wave by choosing a first and sixth subcarrier with 2Nf-GHz signals being utilized by selecting the first and (2N+1)^{th} tones as a signal with an arbitrarily-frequency optical mm-wave signal spaced from f to 2Nf GHz.
